(19) United States
(12) Patent Application Publication
(10) Pub. No.: US 2015/0185890 A1
(43) Pub. Date: Jul. 2, 2015

(54) TRANSPARENT CONDUCTOR, INPUT DEVICE AND ELECTRONIC APPARATUS

(71) Applicant: DEXERIALS CORPORATION, Tokyo (JP)

(72) Inventors: Naoto Kaneko, Sendai-shi (JP); Mikihisa Mizuno, Sendai-shi (JP)

(21) Appl. No.: 14/423,584

(22) PCT Filed: Aug. 19, 2013
(86) PCT No.: PCT/JP2013/072046

§ 371 Date: Feb. 24, 2015

(30) Foreign Application Priority Data
Aug. 31, 2012 (JP) 2012-192604

(51) Int. Cl. G06F 3/041

(52) U.S. Cl. CPC G06F 3/041

(57) ABSTRACT

A transparent conductor having high contrast and capable of suppressing an increase in sheet resistance, is provided with a substrate, a transparent conductive layer containing a metal filler, and a light transmissive layer containing a light-absorbing material.

### TECHNICAL FIELD

The present invention relates to a transparent conductor, an input device, and an electronic apparatus. More specifically, the present invention relates to a transparent conductor provided with a transparent conductive layer containing a metal filler.

### BACKGROUND ART

A transparent conductive layer constitutes a main component indispensable for producing touch panels, FPDs (flat panel displays), solar cells, EMI (Electro-Magnetic Interference), optical filters, and the like in electronics industries, thus attracting wide attention and being expected to be a further expansion of use.

Currently, an ITO (Indium Tin Oxide) film is most commonly used as a transparent conductive layer. However, there are some problems in the ITO film such as having poor optical characteristics and exhibiting a visible pattern when patterning is performed. As for a film forming method, a dry process such as a vacuum deposition method and a sputtering method is commonly used, however, the dry process suffers from a drawback of increasing costs as manufacturing apparatus are increased in size to cope with a recent trend to large-sized substrates on which films are formed.

In contrast, a transparent conductive layer containing a metal filler exhibits more excellent properties than the ITO film in terms of optical characteristics such as transmittance and haze when sheet resistance of the transparent conductive layer is adjusted to the same level as the ITO film. Further, owing to the availability of wet coating methods in the production method, the transparent conductive layer can be manufactured from plastic materials that are light weighted, inexpensive, and flexible through a roll-to-roll process ensuring low manufacturing costs.

A transparent conductive layer containing a metal filler exhibits high brightness resulting from reflection of light caused by metallic luster (a reflection L value represents a value of brightness) and decreased contrast. To solve this problem, a technique for reducing the reflection L value by a surface treatment of the metal filler with a dye has been proposed (for example, see Patent Literature 1).

### CITATION LIST

### Patent Literature

Patent Literature 1: Japanese Patent No. 4893867.

### SUMMARY OF INVENTION

### Technical Problem

However, although the above-mentioned technique can reduce the reflection L value, it also causes an increase in sheet resistance.

Accordingly, an object of the present technique is to provide a transparent conductor, an input device, and an electronic apparatus having high contrast and capable of suppressing an increase in sheet resistance.

### Solution to Problem

A first technique is a transparent conductor provided with:

a substrate;

a transparent conductive layer containing a metal filler; and

a light transmissive layer containing a light-absorbing material.

A second technique is an input device provided with:

a transparent conductive layer containing a metal filler; and

a light transmissive layer containing a light-absorbing material.

A third technique is an electronic apparatus provided with:

a display device; and

an input device, wherein

the input device is provided with:

a transparent conductive layer containing a metal filler; and

a light transmissive layer containing a light-absorbing material.

A fourth technique is a transparent conductor provided with:

a substrate;

a transparent conductive layer containing a metal filler; and

a light transmissive layer containing a light-absorbing material, wherein

at least part of a surface of the metal filler is coated with a colored compound.

Since the present technique adopts a light transmissive layer containing a light-absorbing material, light reflected by a metal filler contained in a transparent conductive layer 12 can be absorbed by the light-absorbing material contained in the light transmissive layer. Therefore, the contrast can be improved by the present technique.

Furthermore, since the present technique improves the contrast by additionally adopting the light transmissive layer containing the light-absorbing material instead of applying a surface treatment to the metal filler, high contrast is achieved without leading to an increase in sheet resistance.

### Advantageous Effects of Invention

As described above, according to the present technique, there is provided a transparent conductor having high contrast and capable of suppressing an increase in sheet resistance.

### BRIEF DESCRIPTION OF DRAWINGS

FIG. 1 is a cross-sectional view showing a configuration example of a transparent conductor in accordance with a first embodiment of the present technique.

FIG. 2 is a cross-sectional view showing a configuration example of a transparent conductor in accordance with a second embodiment of the present technique.

FIG. 3A is a plan view showing a configuration example of a transparent conductor in accordance with a third embodiment of the present technique. FIG. 3B is a cross-sectional view showing the configuration example of the transparent conductor in accordance with the third embodiment of the present technique.

FIG. 4A is an enlarged cross-sectional view showing a portion of the transparent conductor shown in FIG. 3B. FIG. 4B is a cross-sectional view showing a modification of the transparent conductor in accordance with the third embodiment of the present technique.

FIGS. 5A and 5B are cross-sectional views showing modifications of the transparent conductor in accordance with the third embodiment of the present technique.

FIG. 6A is a plain view showing one side of surfaces of a transparent conductor in accordance with a fourth embodiment of the present technique. FIG. 6B is a plain view showing the other side of the surfaces of the transparent conductor in accordance with the fourth embodiment of the present technique. FIG. 6C is a cross-sectional view showing a configuration example of the transparent conductor in accordance with the fourth embodiment of the present technique.

FIGS. 7A and 7B are cross-sectional views showing modifications of the transparent conductor in accordance with the fourth embodiment of the present technique.

FIG. 8A is a cross-sectional view showing a configuration example of an information input device in accordance with a fifth embodiment of the present technique. FIG. 8B is a cross-sectional view showing a configuration example of a first transparent conductor and a second transparent conductor.

FIG. 9 is a cross-sectional view showing a configuration example of an information input device in accordance with a sixth embodiment of the present technique.

FIG. 10A is a plan view showing a specific example of an information input device in accordance with a seventh embodiment of the present technique. FIG. 10B is a cross-sectional view taken along line a-a shown in FIG. 10A.

FIG. 11A is an enlarged plan view showing the area near the intersection portion C shown in FIG. 10A. FIG. 11B is a cross-sectional view taken along line A-A shown in FIG. 11A.

FIG. 12 is a cross-sectional view showing a configuration example of an information input device in accordance with an eighth embodiment of the present technique.

FIG. 13A is an outer appearance view of a television device representing an example of an electronic apparatus. FIG. 13B is an outer appearance view of a notebook personal computer representing an example of an electronic apparatus.

FIG. 14A is an outer appearance view of a mobile phone representing an example of an electronic apparatus. FIG. 14B is an outer appearance view of a tablet type computer representing an example of an electronic apparatus.

### DESCRIPTION OF EMBODIMENTS

### Overview

As described above, a problem of the technique involving the dye treatment of the surface of the metal filler lies in the fact that while the technique can reduce the reflection L value, it also causes an increase in sheet resistance. As a result of intensive studies to solve this problem, the present inventors have found a technique in which the surface of the metal filler is protected by thiols and/or sulfides in advance in the areas where the metals tend to be eluted, so that the increase in sheet resistance is reduced after the dye treatment of the surface as compared with the case where the dye treatment was performed without the protection described above. However, it is still difficult to completely suppress the increase in sheet resistance with this technique. Therefore, the present inventors have pursued extensive studies on a technique of further suppressing the increase in sheet resistance. As a result, a configuration having both a transparent conductive layer containing a metal filler and a light transmissive layer containing a light-absorbing material has been discovered.

Embodiments of the present technique will be described in the following order with reference to the accompanying drawings.

1. First embodiment (example of transparent conductor)
2. Second embodiment (example of transparent conductor)
3. Third embodiment (example of transparent conductor)
4. Fourth embodiment (example of transparent conductor)
5. Fifth embodiment (example of information input device)
6. Sixth embodiment (example of information input device)
7. Seventh embodiment (example of information input device)
8. Eighth embodiment (example of information input device)
9. Ninth embodiment (example of electronic apparatus)

### 1. First Embodiment

### Configuration of Transparent Conductor

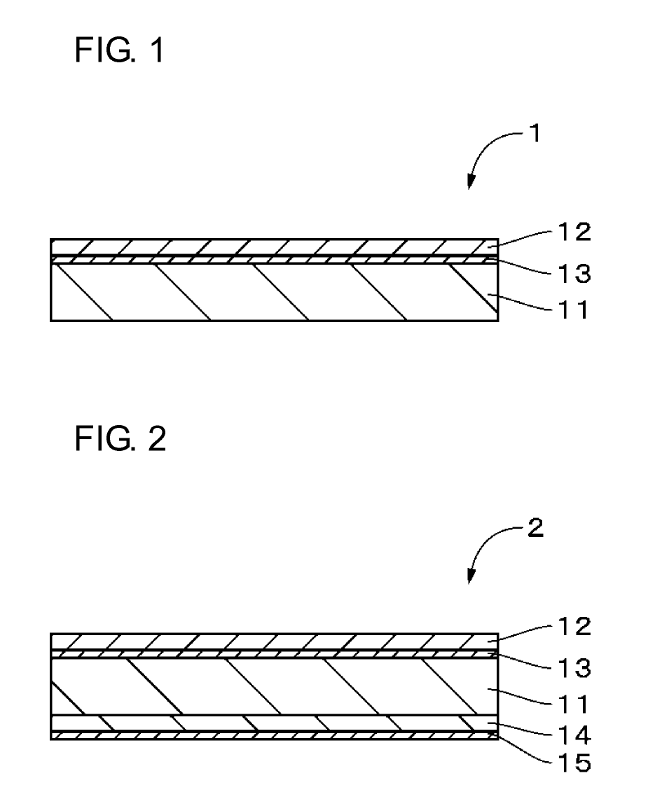

FIG. 1 is a cross-sectional view showing a configuration example of the transparent conductor in accordance with the first embodiment of the present technique. This transparent conductor 1, as shown in FIG. 1, is provided with a substrate 11, a black floating prevention layer 13, which is also a light transmissive layer, and a transparent conductive layer 12. The black floating prevention layer 13 and the transparent conductive layer 12 are laminated on the surface of the substrate 11. The black floating prevention layer 13 is disposed between the substrate 11 and the transparent conductive layer 12. This transparent conductor 1 is suitably applied to a display device and an information input device. In particular, the transparent conductor 1 is suitably applied to an electrostatic capacitance-type touch panel.

### (Substrate)

The substrate 11 is, for example, an inorganic substrate or a plastic substrate having transparency. The substrate 11 may be in a shape of, for example, film, sheet, plate, block, or the like. Examples of the materials of the inorganic substrate may include quartz, sapphire, and glass. Examples of the materials of the plastic substrate used may include known polymer materials. Specific examples of the known polymer materials may include triacetylcellulose (TAC), polyester (TPEE), polyethylene terephthalate (PET), polyethylene naphthalate (PEN), polyimide (PI), polyamide (PA), aramid, polyethylene (PE), polyacrylate, polyether sulfone, polysulfone, polypropylene (PP), polystyrene, diacetyl cellulose, polyvinyl chloride, acrylic resins (PMMA), polycarbonate (PC), epoxy resins, urea resins, urethane resins, melamine resins, phenol resins, acrylonitrile-butadiene-styrene copolymers, cycloolefin polymers (COP), cycloolefin copolymers (COC), PC/PMMA laminates, and rubber-containing PMMA. The substrate 11 is not limited to the examples described above, and substrates containing an inorganic filler and a polymer material may be used. A figure or a pattern may be printed or deposited on the surface of the substrate 11. The thickness of the substrate 11 is preferably within a range of 5 μm to 5 mm. However the thickness of the substrate 11 is not particularly limited to this range, and may be optionally chosen by taking a light transmittance, a moisture vapor transmission rate, and the like into consideration.

### (Transparent Conductive Layer)

The transparent conductive layer 12 contains a metal filler. Preferably the transparent conductive layer 12 further contains a binder in order to improve adhesiveness with the black floating prevention layer 13. The metal filler is preferably dispersed in this binder. The transparent conductive layer 12 may optionally further contain additives such as a dispersant, a thickener, and a surfactant as a component other than the above. The transparent conductive layer 12 may optionally contain a carbon filler. An overcoat layer may be laminated on the transparent conductive layer 12 for the purpose of protecting the transparent conductive layer 12. The overcoat layer preferably has a visible light transmission property. The overcoat layer is composed of, for example, polyacrylic resins, polyamide resins, polyester resins, or cellulose resins, or alternatively, it is composed of hydrolyzates or dehydrated condensates of metal alkoxides, or the like. The overcoat layer may contain a light-absorbing material. Preferably such overcoat layer is formed to have a layer thickness that does not prevent visible light transmission. At least part of the metal filler may be exposed from the surface of the overcoat layer. The overcoat layer may have at least one function selected from the group of functions consisting of a hard coat function, an anti-glare function, an antireflection function, an anti-Newton ring function, and an anti-blocking function.

### (Metal Filler)

The metal filler contains a metal material as a main component. As the metal material, for example, at least one element selected from the group consisting of Ag, Au, Ni, Cu, Pd, Pt, Rh, Ir, Ru, Os, Fe, Co, and Sn may be used.

Examples of the shape of the metal filler may include a spherical shape, an ellipsoidal shape, an acicular shape, a tabular shape, a scale-like shape, a tubular shape, a fibrous shape, a bar-like (rod-like) shape, and an irregular shape, but are not limited only to them in particular. The fibrous shape mentioned above shall include a wire shape. The metal filler having the wire shape is hereinafter referred to as a “metal wire.” The metal filler in two or more kinds of the shapes mentioned above may be combined for use. The spherical shape above may include not only a true sphere shape, but also a nearly spherical shape, in which the true sphere shape is slightly flattened or distorted. The ellipsoidal shape may include not only an exact ellipsoidal shape, but also a nearly ellipsoidal shape, in which the exact ellipsoidal shape is slightly flattened or distorted.

The metal filler is, for example, a fine metal nano filler having a diameter of the nm order. For example, when the metal filler is a metal wire, a preferable form of the metal wire has an average minor axis diameter of greater than 1 nm and 500 nm or smaller, and an average major axis length of longer than 1 μm and 1000 μm or shorter. When the average minor axis diameter is 1 nm or smaller, such metal wires are deteriorated in conductivity and hardly function as a conductive layer after coated. On the other hand, when the average minor axis diameter is greater than 500 nm, a total light transmittance of the transparent conductive layer 12 is deteriorated. Further, when the average major axis length is 1 μm or shorter, such metal wires are hardly connected to each other, and the transparent conductive layer 12 hardly functions as a conductive layer. On the other hand, when the average major axis length is greater than 1000 μm, the total light transmittance of the transparent conductive layer 12 is deteriorated, as well as dispersibility of the metal wires tends to be deteriorated in a coating material used for forming the transparent conductive layer 12. In addition, the metal filler may be formed into a wire shape, in which metal nanoparticles are connected in a beaded state. In this case, the length of the wire is not limited.

The basis weight of the metal wire is preferably from 0.001 to 1.000 [g/m²]. When the basis weight is less than 0.001 [g/m²], the metal wire is not sufficiently present in the transparent conductive layer 12, and conductivity of the transparent conductive layer 12 is deteriorated. On the other hand, although sheet resistance decreases as the basis weight of the metal wire becomes larger, when the basis weight is greater than 1.000 [g/m²], the total light transmittance of the transparent conductive layer 12 is deteriorated.

### (Binder)

The binder may be any binder that is sufficiently adhesive after curing, and an organic or an inorganic binder may be used. The binder may optionally include additives such as a polymerization initiator, a light stabilizer, an ultraviolet absorber, a light-absorbing material, an antistatic agent, a lubricant, a leveling agent, a defoaming agent, a flame retardant, an infrared absorber, a surfactant, a viscosity modifier, a dispersant, a curing-accelerating catalyst, a plasticizer, and a stabilizer such as an antioxidant and an anti-sulfuration agent.

As the organic binder, for example, resin materials such as known transparent natural polymeric resins or synthetic polymeric resins may be used. More specifically, as the organic binder, thermoplastic resins, thermosetting resins, and energy ray-curable resins may be used alone or in combination of two or more of them. Examples of the thermoplastic resins may include polyvinyl chloride, vinyl chloride-vinyl acetate copolymers, polymethyl metacrylate, nitrocellulose, chlorinated polyethylene, chlorinated polypropylene, vinylidene fluoride, ethyl cellulose, and hydroxypropylmethyl cellulose.

The energy ray-curable resin means a resin that can be cured by irradiation with an energy ray. The energy ray refers to a ray having energy capable of triggering polymerization reactions caused by radicals, cations, anions, and the like, and examples of such ray may include electron rays, ultraviolet rays, infrared rays, laser beams, visible rays, ionizing radiations (X-rays, α-rays, β-rays, γ-rays, and the like), microwaves, and high frequencies. The energy ray-curable resin may be optionally mixed with other resins, for example, other curable resins such as thermosetting resins for use. Further, the energy ray-curable resin may be composed of an organic-inorganic hybrid material. Moreover, two or more kinds of the energy ray-curable resins may be mixed for use. As the energy ray-curable resin, an ultraviolet-curable resin that is cured by ultraviolet rays is preferably used.

Examples of compositions of the thermosetting resin and the energy ray-curable resin may include melamine acrylate, urethane acrylate, isocyanate, epoxy resins, polyimide resins, silicon resins such as acrylic modified silicate, polyvinyl alcohol resins, polyvinyl pyrrolidone resins, saponified polyvinyl acetate resins, polyoxyalkylene resins, polyacrylamide resins, and cellulose resins.

The inorganic binder is not limited to a particular one, so long as the inorganic binder can exhibit sufficient adhesion and transparent properties.

Nevertheless examples of the inorganic binder may include hydrolyzates and dehydrated condensates of metal alkoxides. Specific examples of such materials may include, for instance, SiO₂, TiO₂, and ZnO.

### (Black Floating Prevention Layer)

The black floating prevention layer 13 is a light transmissive layer (filter layer) that transmits visible light incident on the transparent conductor 1. A light transmittance in the black floating prevention layer 13 is preferably 50% or higher, more preferably 70% or higher, and further preferably 90% or higher with respect to visible light. When the transmittance is less than 50%, it becomes difficult to apply the transparent conductor 1 to a display device, an information input device, and the like. Visible light described herein refers to light included in a wavelength band between about 360 nm or more and 830 nm or less.

The black floating prevention layer 13 is an optical layer containing a light-absorbing material for absorbing at least visible light, and is also a so-called filter layer. The black floating prevention layer 13 preferably further contains a binder in order to improve adhesion to the substrate 11. The light-absorbing material is preferably dispersed in the binder. The transparent conductive layer 12 may optionally contain additives such as a curing agent, a catalytic agent, a dispersant, a surfactant, and a viscosity modifier as a component other than the above.

The light-absorbing material is not limited to a particular one, so long as the light-absorbing material can exhibit an absorption characteristic of at least visible light, and a capability of improving the contrast of the transparent conductor 1. As the light-absorbing material, organic materials or inorganic materials may be used, further, conductive materials or nonconductive materials may be used. A preferable light-absorbing material can prevent or suppress deterioration of various kinds of characteristics, such as an increase in sheet resistance, a decrease in transmittance, an increase in haze, and the like in the transparent conductor 1, to a low level. Taking such perspectives into consideration, the light-absorbing material preferably includes at least one kind of component selected from colored compounds and carbon materials that absorb at least visible light. The light-absorbing material capable of providing a high aperture ratio is preferable in order to improve transmission characteristics of the transparent conductor 1.

### (Binder)

The binder used is the same binder contained in the transparent conductive layer 12 described above.

### (Colored Compound)

A colored compound has a chromophore [R] exhibiting absorption, for example, in a visible light region. The chromophore [R] is, for example, at least one kind selected from the group consisting of an unsaturated alkyl group, an aromatic ring, a heterocyclic ring, and a metal ion. Specific examples of such chromophore [R] may include a nitroso group, a nitro group, an azo group, a methine group, an amino group, a ketone group, a thiazolyl group, a naphthoquinone group, stilbene derivatives, indophenol derivatives, diphenylmethane derivatives, anthraquinone derivatives, triarylmethane derivatives, diazine derivatives, indigoide derivatives, xanthene derivatives, oxazine derivatives, phthalocyanine derivatives, acridine derivatives, thiazine derivatives, sulfur atom-containing compounds, and metal ion-containing compounds. Further, as the chromophore [R], at least one kind selected from the group consisting of the chromophores exemplified above, and compounds containing such chromophores may be used. In order to improve the transparency of the transparent conductive layer 12, it is preferable to use at least one kind selected from the group consisting of cyanine, quinone, ferrocene, triphenylmethane, and quinolone as the chromophore [R]. Further, at least one kind selected from the group consisting of Cr complexes, Cu complexes, azo groups, indoline groups, and compounds containing such moieties may be used as the chromophore [R].

Examples of the colored compounds mentioned above may include dyes such as acid dyes and direct dyes. One specific examples of such dyes are dyes bearing a sulfonyl group, and may include Kayakalan Bordeaux BL, Kayakalan Brown GL, Kayakalan Gray BL167, Kayakalan Yellow GL143, Kayakalan Black 2RL, Kayakalan Black BGL, Kayakalan Orange RL, Kayarus Cupro Green G, Kayarus Supra Blue MRG, Kayarus Supra Scarlet BNL200, which are manufactured by Nippon Kayaku Co., Ltd., and Lanyl Olive BG manufactured by Taoka Chemical Co., Ltd. Other examples may include Kayalon Polyester Blue 2R-SF, Kayalon Microester Red AQ-LE, Kayalon Polyester Black ECX300, and Kayalon Microester Blue AQ-LE which are manufactured by Nippon Kayaku Co., Ltd. Further, examples of dyes bearing a carboxyl group are dyes for dye-sensitized solar cell, and may include Ru complex-based dyes such as N3, N621, N712, N719, N749, N773, N790, N820, N823, N845, N886, N945, K9, K19, K23, K27, K29, K51, K60, K66, K69, K73, K77, Z235, Z316, Z907, Z907Na, Z910, Z991, CYC-B1, and HRS-1, and organic dyes such as Anthocyanine, WMC234, WMC236, WMC239, WMC273, PPDCA, PTCA, BBAPDC, NKX-2311, NKX-2510, NKX-2553 (manufactured by Hayashibara Co., Ltd.), NKX-2554 (manufactured by Hayashibara Co., Ltd.), NKX-2569, NKX-2586, NKX-2587 (manufactured by Hayashibara Co., Ltd.), NKX-2677 (manufactured by Hayashibara Co., Ltd.), NKX-2697, NKX-2753, NKX-2883, NK-5958 (manufactured by Hayashibara Co., Ltd.), NK-2684 (manufactured by Hayashibara Co., Ltd.), Eosin Y, Mercurochrome, MK-2 (manufactured by Soken Chemical & Engineering Co., Ltd.), D77, D102 (manufactured by Mitsubishi Paper Mills Ltd.), D120, D131 (manufactured by Mitsubishi Paper Mills Ltd.), D149 (manufactured by Mitsubishi Paper Mills Ltd.), D150, D190, D205 (manufactured by Mitsubishi Paper Mills Ltd.), D358 (manufactured by Mitsubishi Paper Mills Ltd.), JK-1, JK-2, 5, ZnTPP, H2TC1PP, H2TC4PP, Phthalocyanine Dye (Zinc phtalocyanine-2,9,16,23-tetra-carboxylic acid, 2-[2′-(zinc 9′,16′,23′-tri-tert-butyl-29H,31H-phthalocyanyl)]succinic acid, Polythiohene Dye (TT-1), Pendant type polymer, and Cyanine Dye (P3TTA, C1-D, SQ-3, and B1).

As the colored compounds, colored compounds used in paints and the like may also be used, and examples thereof may include Opera Red, Permanent Scarlet, Carmine, Violet, Lemon Yellow, Permanent Yellow Deep, Skyblue, Permanent Green Light, Permanent Green Middle, Burnt Sienna, Yellow Ocher, Permanent Orange, Permanent Lemon, Permanent Red, Viridian (Hue), Cobalt Blue (Hue), Prussian Blue (Hue), Jet Black, and the like, manufactured by Turner Colour Works Ltd. Further, for example, colored compounds manufactured by Holbein Works Ltd., such as Bright Red, Cobalt Blue Hue, Ivory Black, Yellow Ochre, Permanent Green Light, Permanent Yellow Light, Burnt Sienna, Ultramarine Deep, Vermilion Hue, Permanent Green, and the like may also be used. Among these colored compounds, Permanent Scarlet, Violet, and Jet Black manufactured by Turner Colour Works Ltd. are preferable.

As the colored compounds, colored compounds used in food may also be used, and examples thereof may include Food Red No. 2 Amaranth, Food Red No. 3 Erythrosine, Food Red No. 102 New Coccine, Food Red No. 104 Phloxine, Food Red No. 105 Rose Bengal, Food Red No. 106 Acid Red, Food Blue No. 1 Brilliant Blue, Food Red No. 40 Allura Red, Food Blue No. 2 Indigo Carmine, Red No. 226 Helindone Pink CN, Red No. 227 Fast Acid Magenta, Red No. 230 Eosin YS, Green No. 204 Pyranine Conc, Orange No. 205 Orange II, Blue No. 205 Alphazurine, Violet No. 401 Alizurol Purple, and Black No. 401 Naphthol Blue Black, manufactured by Daiwa Fine Chemicals Co., Ltd. Further, natural colored compounds may also be used, and examples thereof may include High Red G-150 (water soluble, grape skin dye), Cochineal Red AL (water soluble, cochineal dye), High Red MC (water soluble, cochineal dye), High Red BL (water soluble, beet red), Daiwamonascus LA-R (water soluble, monascus dye), High Red V80 (water soluble, purple sweet potato dye), Annatto-N2R-25 (water dispersible, annatto dye), Annatto-WA-20 (water-soluble annatto, annatto dye), High Orange SS-44R (water dispersible and low-viscosity product, capsicum dye), High Orange LH (oil soluble, capsicum dye), High Green B (water soluble, green colorant preparation), High Green F (water soluble, green colorant preparation), High Blue AT (water soluble, gardenia blue dye), High Melon P-2 (water soluble, green colorant preparation), High Orange WA-30 (water dispersible, capsicum dye), High Red RA-200 (water soluble, red radish dye), High Red CR-N (water soluble, red cabbage dye), High Red EL (water soluble, elderberry dye), and High Orange SPN (water dispersible, capsicum dye), manufactured by Daiwa fine chemicals Co., Ltd.

### (Carbon Material)

As a carbon material, for example, at least one kind selected from the group consisting of carbon, carbon black, acetylene black, graphemes, carbon nanotubes, carbon micro coils, carbon nanohorns, highly oriented pyrolytic graphites (HOPG), natural graphites, vapor grown carbon fibers (VGCF), pitch-based carbon fibers, and mesocarbon microbeads (MCMB), may be used.

Examples of the shape of the carbon material may include a spherical shape, an ellipsoidal shape, an acicular shape, a tabular shape, a scale-like shape, a tubular shape, a wire-like shape, a bar-like (rod-like) shape, a fibrous shape, and an irregular shape, but are not limited only to them in particular. The carbon materials in two or more kinds of the shapes mentioned above may be used in combination. The spherical shape above may include not only a true sphere shape, but also a shape, in which the true sphere shape is slightly flattened or distorted, a shape in which irregular structures are formed on the surface of the true sphere shape, or a shape in which these two shape features are exhibited simultaneously. The ellipsoidal shape above may include not only an exact ellipsoidal shape, but also a shape, in which the exact ellipsoidal shape is slightly flattened or distorted, a shape, in which irregular structures are formed on the surface of the exact ellipsoidal shape, or a shape in which these two shape features are exhibited simultaneously.

### [Method of Manufacturing Transparent Conductor]

Next, an example of manufacturing method of the transparent conductor in accordance with the first embodiment of the present technique will be described.

### (Preparation Step of Forming Black Floating Prevention Layer)

First, a coating material for forming the black floating prevention layer is prepared by adding and dispersing a light-absorbing material in a solvent. Binders and/or additives may be optionally further added to the solvent. If necessary, additives such as a surfactant, a viscosity modifier, and a dispersant may be further added to the solvent in order to improve coating performance over the substrate 11 and a pot life of the composition. Preferable dispersion methods may include mixing, ultrasonic dispersion, dispersion with beads, kneading, and treatment with a homogenizer.

The solvent is not limited to a particular one, so long as the solvent can solve and disperse light-absorbing materials. Examples of such solvent may include water, ethanol, methyl ethyl ketone, isopropyl alcohol, acetone, anone (cyclohexanone and cyclopentanone), hydrocarbons (hexane), amides (DMF), sulfides (DMSO), butyl cellosolve, butyl triglycol, propylene glycol monomethyl ether, propylene glycol monoethyl ether, ethylene glycol monoethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, methyl glycol, terpineol, and butyl carbitol acetate.

### (Preparation Step of Coating Material for Forming Transparent Conductive Layer)

Next, a coating material for forming the transparent conductive layer is prepared by adding and dispersing a metal filler in a solvent. Binders and/or additives may be optionally further added to the solvent. For example, a dispersant for enhancing dispersibility of the metal filler, or other additives for improving adhesiveness and durability may be added to the solvent. Preferable dispersion methods may include mixing, ultrasonic dispersion, dispersion with beads, kneading, and treatment with a homogenizer.

Provided the content of the coating material as 100 parts by mass, the blending amount of the metal filler in the coating material is set to 0.01 to 10.00 parts by mass. If the amount of the metal filler is less than 0.01 parts by mass, a sufficient amount of the metal filler in basis weight (for example, 0.001 to 1.000 [g/m²]) cannot be obtained in the resulting transparent conductive layer 12. On the other hand, if the amount of the metal filler is greater than 10 parts by mass, dispersibility of the metal filler tends to decrease. When the dispersant is added to the coating material, the amount of the dispersant is preferably set to such a level as not deteriorating electric conductivity of the resulting transparent conductive layer 12.

The solvent is not limited to a particular one, so long as the solvent can disperse the metal filler. For example, at least one kind selected from the group consisting of water, alcohols (for example, methanol, ethanol, n-propanol, i-propanol, n-butanol, i-butanol, sec-butanol, and tert-butanol), anone (for example, cyclohexznone and cyclopentanone), amides (for example, N,N-dimethylformamide: DMF), and sulfides (for example, dimethyl sulfoxide: DMSO) may be used as the solvent.

In order to suppress the occurrence of uneven drying or cracks in a coating film, a high boiling point solvent may be further included in the solvent, thereby controlling the evaporation rate of the solvent from the coating material. Examples of the high boiling point solvent may include buthylcellosolve, diacetone alcohol, butyl triglycol, propylene glycol monomethyl ether, propylene glycol monoethyl ether, ethylene glycol monoethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, and methyl glycol. These high boiling point solvents may be used alone or two or more of them may be used in combination.

### (Coating Step of Coating Material for Forming Black Floating Prevention Layer)

Next, the coating material for forming the black floating prevention layer prepared as described above is applied to the surface of the substrate 11 to form a coating film. A method of forming the coating film is not limited to a particular one, however, a wet film forming method is preferable in consideration of physical properties, convenience, manufacturing costs, and the like. As the wet film forming method, for example, well-known methods such as a coating method, a spraying method, and a printing method may be used. The coating methods are not limited to particular ones, and well-known coating methods may be used. Examples of the well-known coating methods may include a micro gravure coating method, a wire bar coating method, a direct gravure coating method, a die coating method, a dipping method, a spray coating method, a reverse roll coating method, a curtain coating method, a comma coating method, a knife coating method, and a spin coating method. Examples of the printing methods may include a letterpress printing method, an offset printing method, a gravure printing method, an intaglio printing method, a rubber plate printing method, a screen printing method, and an inkjet printing method.

### (Dry-Curing Step of Coating Film)

Next, the coating film formed on the surface of the substrate 11 is dried in order to volatilize the solvent. Drying conditions are not limited to particular ones, and either natural drying or heat drying method may be used. The heat drying process may also serve as a firing step concurrently. Thus, the black floating prevention layer 13 is formed on the surface of the substrate 11.

### (Coating Step of Coating Material for Forming Transparent Conductive Layer)

Next, the coating material for forming the transparent conductive layer prepared as described above is applied to the surface of the black floating prevention layer 13 to form a coating film in which the metal filler is dispersed. A method of forming the coating film is not limited to a particular one, however, a wet film forming method is preferable in consideration of physical properties, convenience, manufacturing costs, and the like. As the wet film forming method, for example, well-known methods such as a coating method, a spraying method, and a printing method may be used. The coating methods are not limited to particular ones, and well-known coating methods may be used. Examples of the well-known coating methods may include a micro gravure coating method, a wire bar coating method, a direct gravure coating method, a die coating method, a dipping method, a spray coating method, a reverse roll coating method, a curtain coating method, a comma coating method, a knife coating method, and a spin coating method. Examples of the printing methods may include a letterpress printing method, an offset printing method, a gravure printing method, an intaglio printing method, a rubber plate printing method, a screen printing method, and an inkjet printing method.

### (Dry-Curing Step of Coating Film)

Next, the solvent existing in the coating film formed on the surface of black floating prevention layer 13 is removed by drying. Drying conditions are not limited to particular ones, and either natural drying or heat drying method may be used. Then, an uncured binder is cured, for example, by heat treatment or energy ray irradiation as necessary. This leads to the condition where the metal filler is dispersed in the cured binder. When an energy ray curable resin is used as the binder in this process, the uncured binder may be cured by energy ray irradiation through a photomask to form cured regions with a pattern. Subsequently, development processing is performed by a water-based or alcohol-based solution, thereby forming an electrode pattern, in which transparent conductive parts and transparent insulation parts are arranged alternately within a plane on the surface of the black floating prevention layer 13. Next, the coating film is optionally subjected to firing. The heat drying process may also serve as a firing step concurrently. Next, pressurization treatment by a calender may be optionally performed to reduce sheet resistance of the resulting transparent conductive layer 12. Thus, the transparent conductive layer 12 is formed on the surface of the black floating prevention layer 13.

Accordingly, the transparent conductor 1 as the target product is obtained. Etching processing may be performed on the transparent conductive layer 12 by providing an etching mask formed on the surface of the transparent conductive layer 12, thereby allowing a formation of an electrode pattern, in which transparent conductive parts and transparent insulation parts are arranged alternately within a plane on the surface of the black floating prevention layer 13.

### [Effects]

According to the first embodiment, by providing the black floating prevention layer 13 between the substrate 11 and the transparent conductive layer 12, light reflected by the metal filler contained in the transparent conductive layer 12 can be absorbed by the light-absorbing material in the black floating prevention layer 13. Thus the contrast of the transparent conductor 1 can be improved.

Since the contrast of the transparent conductor 1 is improved by further including the black floating prevention layer 13 instead of applying a surface treatment to the metal filler, high contrast can be achieved without causing an increase in sheet resistance. At least part of the surface of the metal filler may be coated with a colored compound by performing a surface treatment to the metal filler with the colored compound within a certain extent in which desired sheet resistance is obtainable. The contrast is further improved by this treatment.

As the colored compound for use in coating the surface of the metal filler, for example, the same colored compound contained in the black floating prevention layer 13 may be used. The colored compound may be attached to the surface of the metal filler, for example, by adsorption. The term adsorption herein refers to the phenomenon in which the colored compound stays on or near the surface of the metal filler. Adsorption may be established by chemical adsorption, physical adsorption, or a combination thereof. Chemical adsorption refers to adsorption occurring between the surface of the metal filler and the colored compound, accompanied by chemical bonds such as covalent bonds, ionic bonds, metallic bonds, coordinate bonds, and hydrogen bonds. Physical adsorption refers to adsorption caused by an interaction such as Van der Waals force, electrostatic attraction, and magnetic force.

### <Modifications>

Modifications of the first embodiment will be described below.

The transparent conductor 1 having the following configuration (1) was described in the first embodiment above, however, the configuration of the transparent conductor 1 is not limited to this. For example, the following configurations (2) to (15) can also be adopted as the configuration of the transparent conductor 1.

(1) Transparent conductive layer/Black floating prevention layer/Substrate
(2) Transparent conductive layer/Black floating prevention layer/Anchor layer/Substrate
(3) Black floating prevention layer/Transparent conductive layer/Substrate
(4) Black floating prevention layer/Transparent conductive layer/Anchor layer/Substrate
(5) Black floating prevention layer/Transparent conductive layer/Black floating prevention layer/Substrate
(6) Black floating prevention layer/Transparent conductive layer/Black floating prevention layer/Anchor layer/Substrate
(7) Transparent conductor according to any of the configurations (1) to (6)/Hard coat layer
(8) Transparent conductor according to any of the configurations (1) to (7)/Antireflection layer
(9) Transparent conductor according to any of the configurations (1) to (7)/Layer with moth-eye structure
(10) Transparent conductor according to any of the configurations (1) to (9)/Adhesive layer/Substrate
(11) Substrate/Adhesive layer/Transparent conductor according to any of the configurations (1) to (10)
(12) Overcoat layer/Transparent conductor according to any of the configurations (1) to (11)
(13) Antireflection layer/Transparent conductor according to any of the configurations (1) to (12)
(14) Layer with moth-eye structure/Transparent conductor according to any of the configurations (1) to (12)
(15) Substrate/Adhesive layer/Transparent conductor according to the configuration (11)

The adhesive layer in the configurations (10), (11), and (15) may include an air layer, or may be composed of resin materials. Further, the adhesive layer may contain a light-absorbing material. The same light-absorbing material contained in the black floating prevention layer may be used as the light-absorbing material. The overcoat layer in the configuration (12) may be a hard coat layer.

The anchor layer preferably has transparency to visible light. The anchor layer is composed of, for example, polyacrylic resins, polyamide resins, polyester resins, or cellulose resins, or alternatively is composed of hydrolyzates or dehydrated condensates of metal alkoxides, or the like. Preferably the anchor layer is formed to have a layer thickness that does not interfere with visible light transmission.

### 2. Second Embodiment

FIG. 2 is a cross-sectional view showing a configuration example of the transparent conductor in accordance with the second embodiment of the present technique. The transparent conductor 2 in accordance with the second embodiment is different from the transparent conductor 1 in accordance with the first embodiment in that a transparent conductive layer 14 and a black floating prevention layer 15 are further provided. The transparent conductive layer 14 is provided on a surface of the substrate 11 on the opposite side to a surface where the transparent conductive layer 12 is provided. The black floating prevention layer 15 is provided on the surface of the transparent conductive layer 14.

The configuration and the forming method of the transparent conductive layer 14 are the same as those of the transparent conductive layer 12 in the first embodiment mentioned above. The configuration and the forming method of the black floating prevention layer 15 are the same as those of the black floating prevention layer 13 in the first embodiment mentioned above.

### 3. Third Embodiment

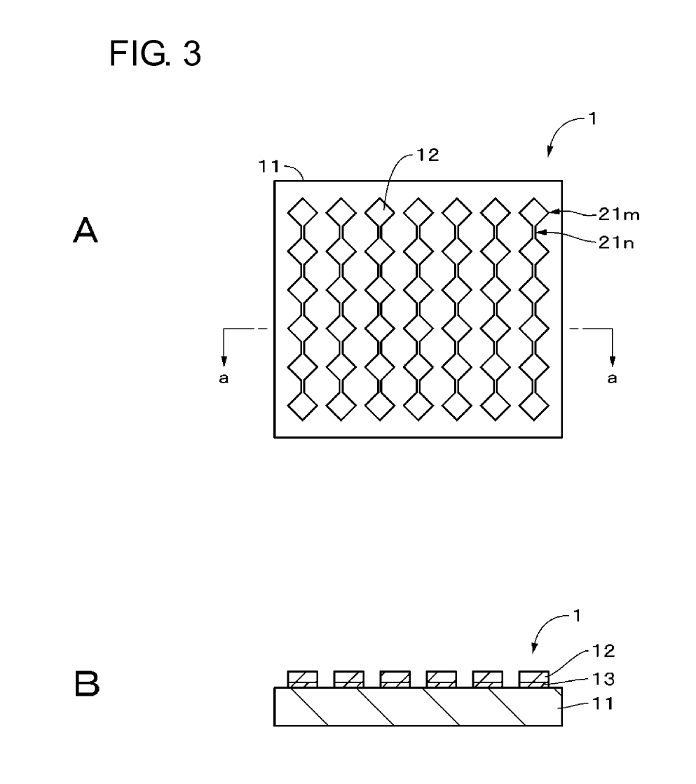

FIG. 3A is a plan view showing a configuration example of the transparent conductor in accordance with the third embodiment of the present technique. FIG. 3B is a cross-sectional view showing the configuration example of the transparent conductor in accordance with the third embodiment of the present technique. The transparent conductor 1 in accordance with the third embodiment is, as shown in FIG. 3A and FIG. 3B, different from the transparent conductor 1 in accordance with the first embodiment in that the transparent conductive layer 12 and the black floating prevention layer 13 are patterned in the same shape. The patterned transparent conductive layer 12 constitutes, for instance, electrodes such as X electrodes or Y electrodes. As such electrodes, as shown in FIG. 3A, electrodes having a plurality of pad portions (unit electrodes) 21m, and a plurality of connection portions 21n connecting the plurality of the pad portions 21m with each other may be used. The configuration of electrodes is not limited to this example, and electrodes arrayed in a stripe-like (linear) pattern, for example, may be used. FIG. 3B shows an example in which the transparent conductive layer 12 and the black floating prevention layer 13 are patterned in the same shape, however, the black floating prevention layer 13 may continuously coat the entire surface of the electrode forming area of the substrate 11, instead of being patterned.

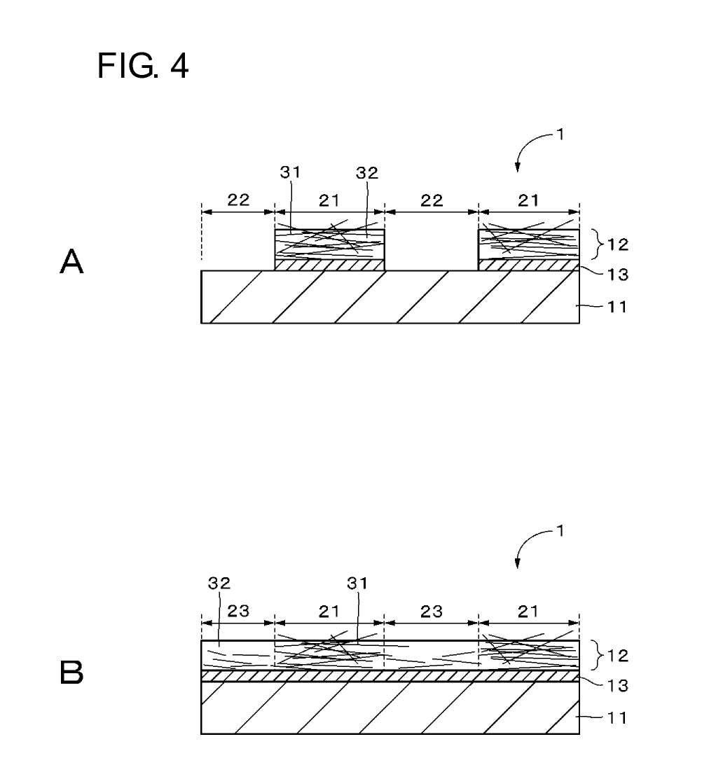

FIG. 4A is an enlarged cross-sectional view showing part of the patterned transparent conductive layer 12 and black floating prevention layer 13. FIG. 4A shows an example of the transparent conductive layer 12 containing a metal wire 31 and a binder 32. As shown in FIG. 4A, insulating regions 22 are formed between adjacent electrodes 21 by removing the transparent conductive layer 12 located between the electrodes 21. The configuration of the insulating regions 22 is not limited to this example, and, as shown in FIG. 4B, the insulating regions 23 may also be formed between adjacent electrodes 21 by disconnecting the metal wires 31. In this case, the transparent conductive layer 12 remains in the parts to become the insulating regions 23. Disconnection of the metal wires 31 mentioned above can be achieved by adjusting etching conditions of the transparent conductive layer 12 during the manufacturing process of the transparent conductor 1.

### <Modifications>

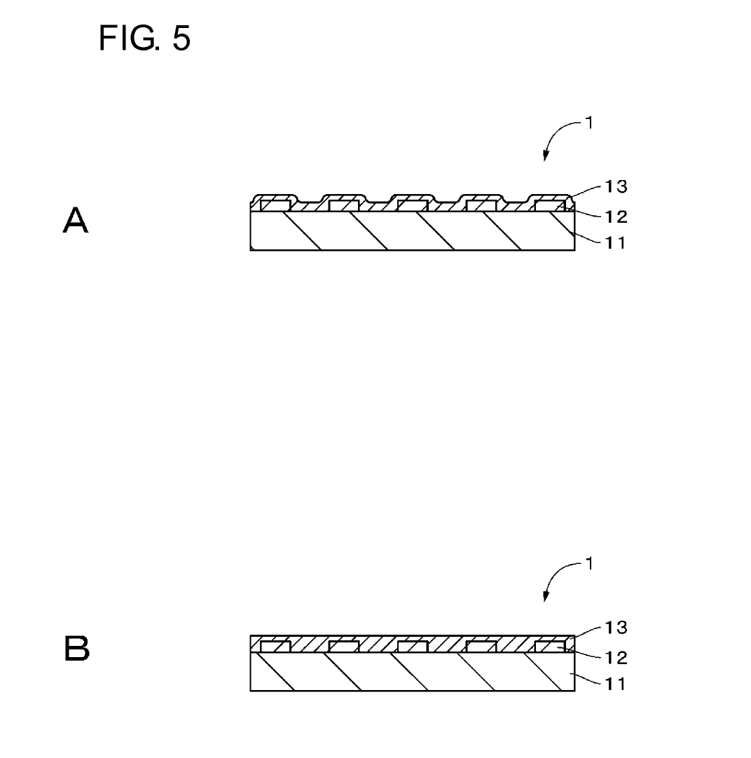

When the black floating prevention layer 13 is formed on the surface of the patterned transparent conductive layer 12, the black floating prevention layer 13 may be formed so as to conform to the shape of the patterned transparent conductive layer 12, as shown in FIG. 5A. Alternatively, the patterned transparent conductive layer 12 may be embedded inside of the black floating prevention layer 13, thereby making the surface of the black floating prevention layer 13 uniformly flat, as shown in FIG. 5B.

### 4. Fourth Embodiment

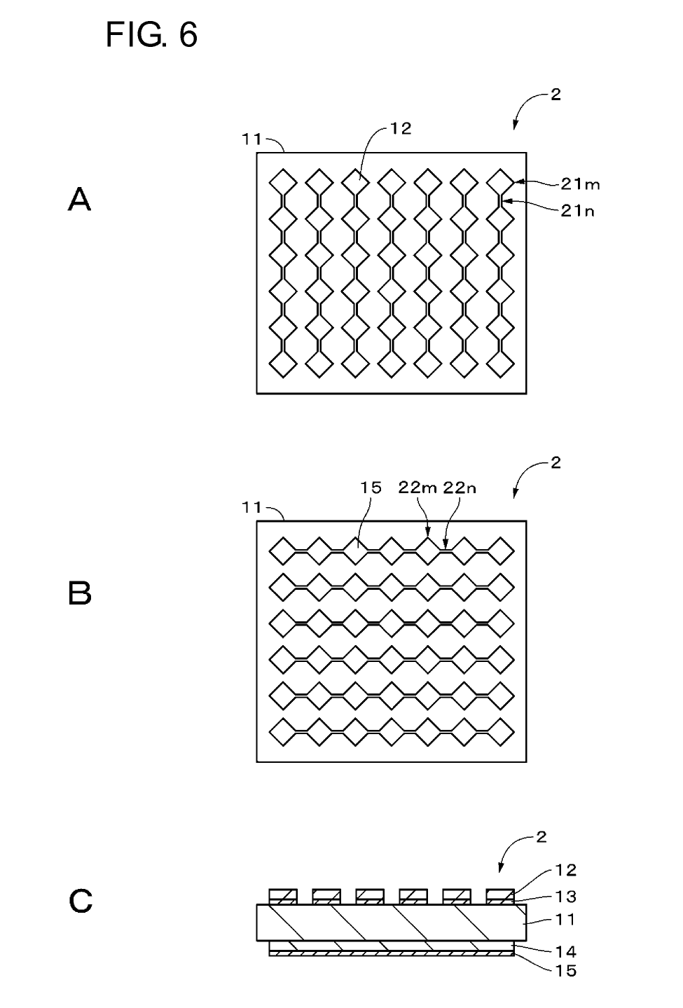

FIG. 6A is a plan view showing one side of the surfaces of the transparent conductor in accordance with the fourth embodiment of the present technique. FIG. 6B is a plan view showing the other side of the surfaces of the transparent conductor in accordance with the fourth embodiment of the present technique. FIG. 6C is a cross-sectional view showing a configuration example of the transparent conductor in accordance with the fourth embodiment of the present technique. The transparent conductor 2 in accordance with the fourth embodiment is different from the transparent conductor 2 in accordance with the second embodiment in that the transparent conductive layer 12 and the black floating prevention layer 13 are patterned in the same shape on one surface (first surface) of the transparent conductor 2, while the transparent conductive layer 14 and the black floating prevention layer 15 are patterned in the same shape on the other surface (second surface) of the transparent conductor 2, as shown in FIG. 6A and FIG. 6B. When viewed from a direction perpendicular to the surface of the transparent conductor 2, the patterned transparent conductive layer 12 is in an orthogonally crossing relation with the patterned transparent conductive layer 14.

The patterned transparent conductive layer 12 constitutes, for example, X electrodes. As such electrodes, electrodes having a plurality of pad portions (unit electrodes) 21m, and a plurality of connection portions 21n connecting the plurality of the pad portions 21m with each other may be used as shown in FIG. 6A. The configuration of electrodes is not limited to this example, and stripe-like (linear) electrodes, for example, may be used.

The patterned transparent conductive layer 14 constitutes, for example, Y electrodes. As such electrodes, electrodes having a plurality of pad portions (unit electrode) 22m, and a plurality of connection portions 22n connecting the plurality of the pad portions 22m with each other may be used as shown in FIG. 6B. The configuration of electrodes is not limited to this example, and stripe-like (linear) electrodes, for example, may be used.

FIG. 6A and FIG. 6B show an example in which the transparent conductive layer 12 and the black floating prevention layer 13 are patterned in the same shape, and the transparent conductive layer 14 and the black floating prevention layer 15 are patterned in the same shape, however, the black floating prevention layers 13 and 15 may continuously coat the entire surface of the electrode formed area of the substrate 11, instead of being patterned.

### <Modifications>

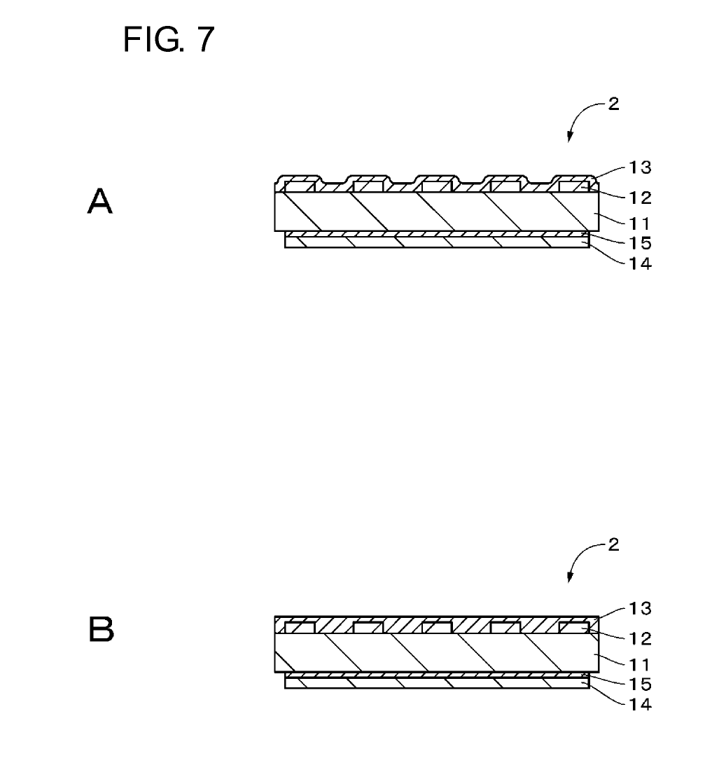

When the black floating prevention layer 13 is provided on the surface of the patterned transparent conductive layer 12, the black floating prevention layer 13 may be formed so as to conform to the shape of the patterned transparent conductive layer 12, as shown in FIG. 7A. Alternatively, the patterned transparent conductive layer 12 may be embedded inside of the black floating prevention layer 13, resulting in forming the flat surface of the black floating prevention layer 13, as shown in FIG. 7B.

### 5. Fifth Embodiment

### Configuration of Information Input Device

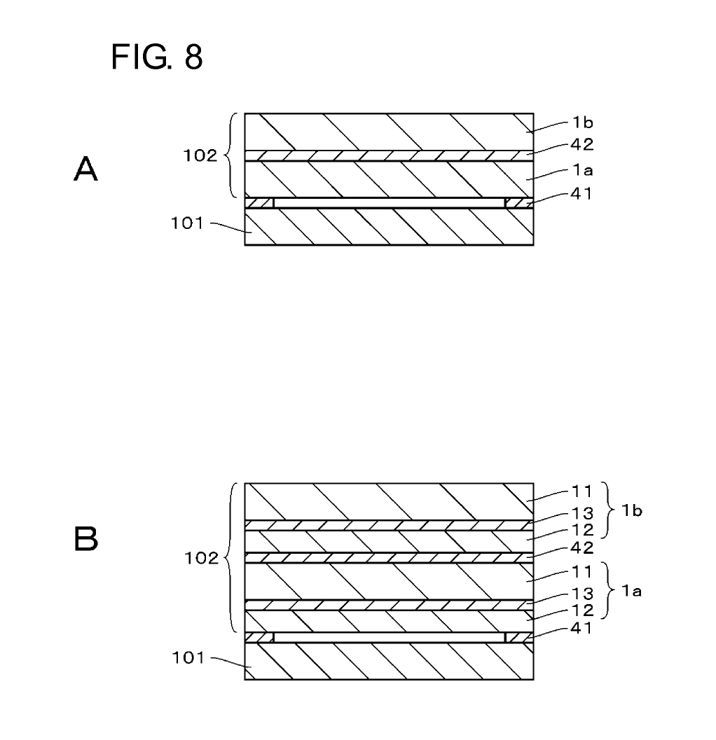

FIG. 8A is a cross-sectional view showing a configuration example of an information input device in accordance with the fifth embodiment of the present technique. As shown in FIG. 8A, an information input device 102 is provided on a display surface of a display device 101. The information input device 102 is pasted together with the display surface of the display device 101, for example, by a pasting layer 41. The pasting layer 41 may be provided only in the peripheral areas of the display surface of the display device 101 and the back surface of the information input device 102. As the pasting layer 41, for example, adhesive pastes, adhesive tapes, and the like are used. In the present specification, a surface of a touch surface (information input surface) for inputting information by an object such as fingers or pens is referred to as a “front surface,” while the opposite side of the front surface is referred to as a “back surface.”

### (Display Device)

The display device 101 to which the information input device 102 is applied is not limited to a particular one, however, examples of the display device 101 may include various kinds of display devices such as liquid crystal displays, CRT (Cathode ray tube) displays, Plasma display panels (PDP), Electro luminescence (EL) displays, Surface-conduction electron-emitter displays (SED), and the like.

### (Information Input Device)

The information input device 102 is so-called a projection type capacitance type touch panel, and is provided with a first transparent conductor 1a and a second transparent conductor 1b provided on the surface of the first transparent conductor 1a. The first transparent conductor 1a and the second transparent conductor 1b are pasted together via a pasting layer 42.

### (First Transparent Conductor and Second Transparent Conductor)

FIG. 8B is a cross-sectional view showing a configuration example of the first transparent conductor and the second transparent conductor. The transparent conductor 1 in accordance with the third embodiment described above may be used as the first transparent conductor 1a and the second transparent conductor 1b. When viewed from a direction perpendicular to the surface of the information input device 102, electrodes of the first transparent conductor 1a (the patterned transparent conductive layer 12) are in an orthogonally crossing relation with electrodes of the second transparent conductor 1b (the patterned transparent conductive layer 12).

In the first transparent conductor 1a, the black floating prevention layer 13 that is also a light transmissive layer is preferably provided at a position closer to the touch surface than the transparent conductive layer 12. This is because light reflected by the metal filler contained in the transparent conductive layer 12 into the direction of the touch surface side (user side) can be absorbed by a light-absorbing material in the black floating prevention layer 13.

Similarly, in the second transparent conductor 1b, the black floating prevention layer 13 that is also the light transmissive layer is preferably provided at a position closer to the touch surface than the transparent conductive layer 12. This is because light reflected by the metal filler contained in the transparent conductive layer 12 into the direction of the touch surface side (user side) can be absorbed by the light-absorbing material in the black floating prevention layer 13.

### 6. Sixth Embodiment

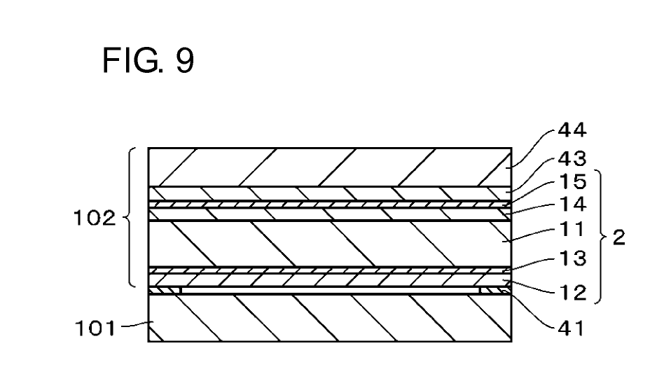

FIG. 9 is a cross-sectional view showing a configuration example of an information input device in accordance with the sixth embodiment of the present technique. This information input device 102 is, as shown in FIG. 9, different from the one described in the fifth embodiment in that the device is provided with the transparent conductor 2 in accordance with the fourth embodiment.

The transparent conductive layer 14 and the black floating prevention layer 15 are laminated on the touch surface side of the transparent conductor 2, while the transparent conductive layer 12 and the black floating prevention layer 13 are laminated on the back surface side, the opposite side of the touch surface. For the transparent conductive layer 14 and the black floating prevention layer 15 laminated on the touch surface side, the black floating prevention layer 15 is preferably provided at a position closer to the touch surface than the transparent conductive layer 14. For the transparent conductive layer 12 and the black floating prevention layer 13 laminated on the back surface side, the black floating prevention layer 13 is preferably provided at a position closer to the touch surface than the transparent conductive layer 12.

A protective layer (optical layer) 44 may be optionally further provided on the touch surface side of the transparent conductor 2. The protective layer 44 is a top plate composed of, for example, glass or plastic. The protective layer 44 and the transparent conductor 2 are pasted together, for example, via a pasting layer 43. The protective layer 44 is not limited to this example, and a ceramic coat (overcoat) containing SiO₂ or the like may be used.

### 7. Seventh Embodiment

### Configuration of Information Input Device

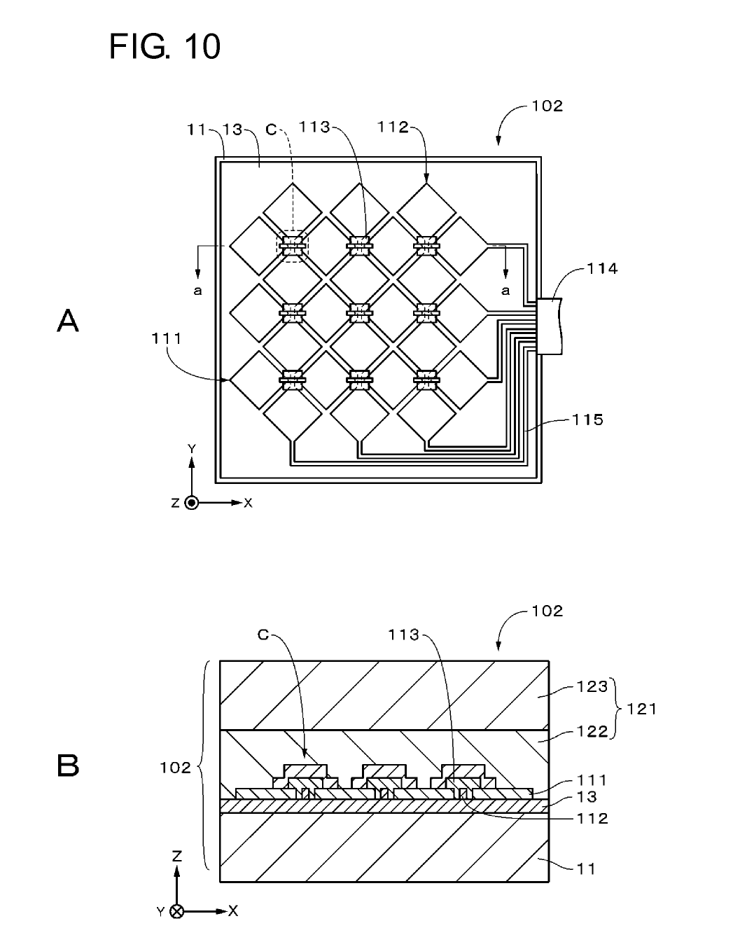

FIG. 10A is a plan view showing a configuration example of an information input device in accordance with the seventh embodiment of the present technique. FIG. 10B is a cross-sectional view taken along line a-a shown in FIG. 10A. The information input device 102 is so-called a projection type capacitance type touch panel, and is provided with a substrate 11, a black floating prevention layer 13, a plurality of transparent electrode portions 111 and transparent electrode portions 112, and a transparent insulation layer 113, as shown in FIG. 10A and FIG. 10B. The plurality of transparent electrode portions 111 and transparent electrode portions 112 are provided on the same surface of the substrate 11. The black floating prevention layer 13 is provided between the substrate 11 and the plurality of transparent electrode portions 111 and transparent electrode portions 112. A black floating prevention layer 13 that is also a light transmissive layer is preferably provided at a position closer to the touch panel than the plurality of transparent electrode portions 111 and transparent electrode portions 112. The transparent insulation layers 113 are interposed at the intersection parts between the transparent electrode portions 111 and the transparent electrode portions 112.

An optical layer 121 may be optionally further provided on the surface of the substrate 11, where the transparent electrode portions 111 and the transparent electrode portions 112 are formed, as shown in FIG. 10B. Note that the description of the optical layer 121 is omitted in FIG. 10A. The optical layer 121 is provided with a pasting layer 122 and a base substance 123, and the base substance 123 is pasted to the surface of the substrate 11 via the pasting layer 122. The information input device 102 is suitably applied to a display surface of a display device. The substrate 11 and the optical layer 121 have transparency, for example, to visible light, and preferably have a refractive index (n) within a range of 1.2 or more and 1.7 or less. Hereinafter, two directions perpendicularly crossing each other within a plane of the surface of the information input device 102 are denoted as X-axis and Y-axis directions, respectively, and a direction perpendicularly to this surface is denoted as a Z-axis direction.

### (Transparent Electrode Portion)

The transparent electrode portions 111 are extended in the X-axis direction (first direction) on the surface of the substrate 11, while the transparent electrode portions 112 are extended in the Y-axis direction (second direction) on the surface of the substrate 11. Thus the transparent electrode portions 111 and the transparent electrode portions 112 orthogonally intersect each other. The transparent insulation layers 113 are interposed at intersection portions C where the transparent electrode portions 111 and the transparent electrode portions 112 intersect each other in order to electrically insulate between the two kinds of electrodes.

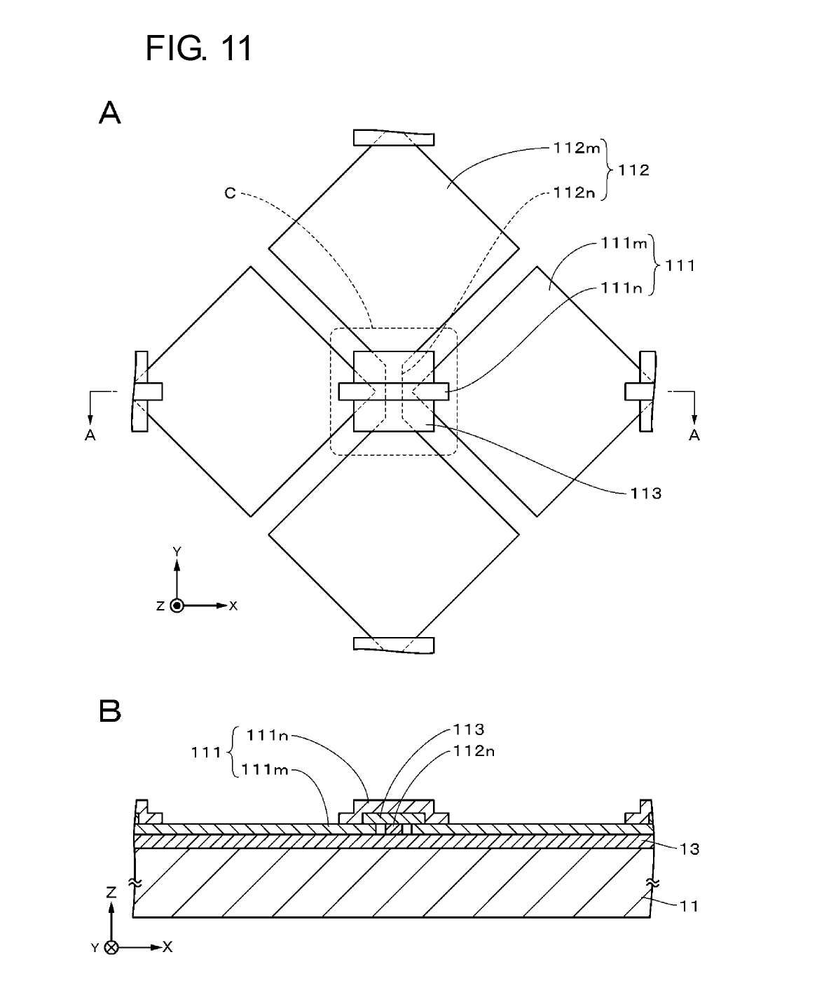

FIG. 11A is an enlarged plan view showing an area near the intersection portion C shown in FIG. 10A. FIG. 11B is a cross-sectional view taken along line A-A shown in FIG. 11A. The transparent electrode portions 111 are provided with a plurality of pad portions (unit electrodes) 111m, and a plurality of connection portions 111n connecting the plurality of the pad portions 111m with each other. The connection portions 111n are extended in the X-axis direction and connect the ends of the adjacent pad portions 111m. The transparent electrode portions 112 are provided with a plurality of pad portions (unit electrodes) 112m, and a plurality of connection portions 112n connecting the plurality of the pad portions 112m with each other. The connection portions 112n are extended in the Y-axis direction and connect the ends of the adjacent pad portions 112m.

The connection portions 112n, the transparent insulation layers 113, and the connection portions 111n are laminated in this order on the surface of the substrate 11 at the intersection portions C. The connection portions 111n are formed so as to extend over the transparent insulation layers 113. One end of each connection portion 111n extending over the transparent insulation layer 113 is electrically connected to one of two adjacent pad portions 111m, and the other end of the connection portion 111n extending over the transparent insulation layer 113 is electrically connected to the other pad portion 111m adjoining the former.

The pad portions 112m and the connection portions 112n are integrally formed, while the pad portions 111m and the connection portions 111n are separately formed. For example, the pad portions 111m, the pad portions 112m, and the connection portions 112n are formed by a single transparent conductive layer provided on the surface of the substrate 11. This transparent conductive layer is composed of the same materials as those for the transparent conductive layer 12 in accordance with the first embodiment described above. The connection portions 111n are, for example formed by a conductive layer.

The shape of the pad portions 111m and the pad portions 112m may include, but is not limited to, for example, a polygonal shape such as a lozenge shape (diamond shape) and a rectangular shape, a star shape, and a cross shape.

As the conductive layer constituting the connection portions 111n, for example, a metal layer or a transparent conductive layer may be used. The metal layer contains a metal as a main component. Metal with high conductivity is preferably used, and examples of such materials may include Ag, Al, Cu, Ti, Nb, and impurity-doped Si. Among them, Ag is preferable in consideration of high conductivity, film formability, and printing property. It is preferable to narrow the width of the connection portions 111n, reduce the thickness thereof, and shorten the length thereof by using a metal with high conductivity as a material of the metal layer. Thus, visibility can be improved.

Rectangular shapes can be adopted as a shape of the connection portions 111n and the connection portions 112n, but the shape is not limited to the rectangular shapes in particular, so long as the shape of the connection portions 111n and the connection portions 112n allows the connection between adjacent pad portions 111m and the connection between adjacent pad portions 112m, respectively. Examples of shapes other than the rectangular shapes may include a linear shape, an elliptical shape, a triangular shape, and an irregular shape.

### (Transparent Insulation Layer)

The transparent insulation layer 113 preferably has a larger area than that of the intersection part where the connection portion 111n and the connection portion 112n intersect. For example, the area of the transparent insulation layer 113 is large enough to cover corners of the pad portion 111m and the pad portion 112m located at the intersection portion C.

The transparent insulation layer 113 contains transparent insulation materials as a main component. As the transparent insulation materials, polymer materials having transparency are preferably used, and examples of such materials may include (meth)acrylic resins such as polymethyl methacrylate, and copolymers of methyl methacrylate and vinyl monomers such as another alkyl(meth)acrylate and styrene; polycarbonate resins such as polycarbonate and diethylene glycol bisallyl carbonate (CR-39); thermosetting (meth)acrylic resins such as homopolymers or copolymers of (brominated) bisphenol A type di(meth)acrylate, and polymers and copolymers of urethane-modified (brominated) bisphenol A type mono(meth)acrylate monomer; and polyester, especially, polyethylene terephthalate, polyethylene naphthalate and unsaturated polyester, acrylonitrile-styrene copolymers, polyvinyl chloride, polyurethane, epoxy resins, polyarylate, polyether sulfone, polyether ketone, cycloolefin polymers (trade names Arton and Zeonor), and cycloolefin copolymers. Further, aramid resins may also be used in consideration of heat-resistant property. Herein (meth)acrylate means acrylate or methacrylate.

The shape of the transparent insulation layer 113 is not limited to a particular one, so long as the shape allows the transparent insulation layer 113 to be interposed between the transparent electrode portion 111 and the transparent electrode portion 112 at the intersection portion C and preventing electric contact between the two types of electrodes. Nevertheless, examples of the shape may include polygons such as quadrangles, ellipses, and circles. Examples of quadrangles may include rectangles, squares, lozenges, trapezoids, parallelograms, and rectangular-like shapes having a curvature R at each corner.

### (Wiring)

One end of each transparent electrode portion 111 and transparent electrode portion 112 is electrically connected to a corresponding wire 115, which is in turn connected to a driving circuit (not shown) via an FPC (Flexible Printed Circuit) 114.

The seventh embodiment is identical to the fifth embodiment other than descried in the above.

### 8. Eighth Embodiment

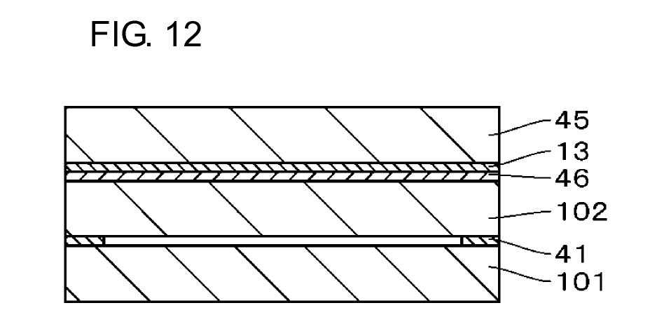

FIG. 12 is a cross-sectional view showing a configuration example of an information input device in accordance with the eighth embodiment of the present technique. A black floating prevention layer 13 is provided on a surface of a base substance 45. This base substance 45 is provided on a display surface of an information input device 102 in such a manner that the black floating prevention layer 13 and the display surface of the information input device 102 are opposite to each other. The base substance 45 and the information input device 102 are pasted together, for example, by a pasting layer 46. As the information input device 102, any of the information input devices 102 in accordance with the fifth to the seventh embodiments may be used. In the information input devices 102 in accordance with the fifth to the seventh embodiments, the configuration may be simplified by omitting the black floating prevention layer 13 or 15 for use. Even in such a case, reflected light caused by the metal filler can be absorbed by the black floating prevention layer 13 provided on the surface of the base substance 45. Thus, the contrast can be improved.

### 9. Ninth Embodiment

The electronic apparatus in accordance with the ninth embodiment is provided with any of the information input devices 102 in accordance with the fifth to the eighth embodiments in a display device. The information input device 102 is provided either on the surface of the display device, or inside of the display device. Examples of the electronic apparatus in accordance with the ninth embodiment of the present technique are described below.

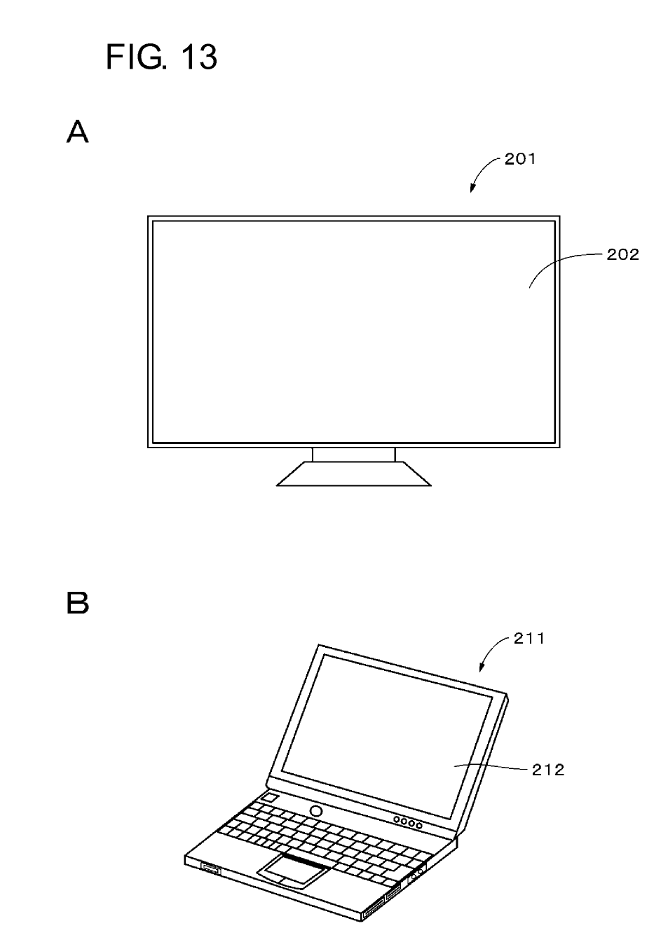

FIG. 13A is an outer appearance view of a television device representing an example of the electronic apparatus. The television device 201 is provided with a display device 202 and any of the information input devices 102 in accordance with the fifth to the eighth embodiments either on the surface or inside of the display device 202.

FIG. 13B is an outer appearance view of a notebook personal computer representing an example of the electronic apparatus. The notebook personal computer 211 is provided with a display device 212 and any of the information input devices 102 in accordance with the fifth to the eighth embodiments either on the surface or inside of the display device 212.

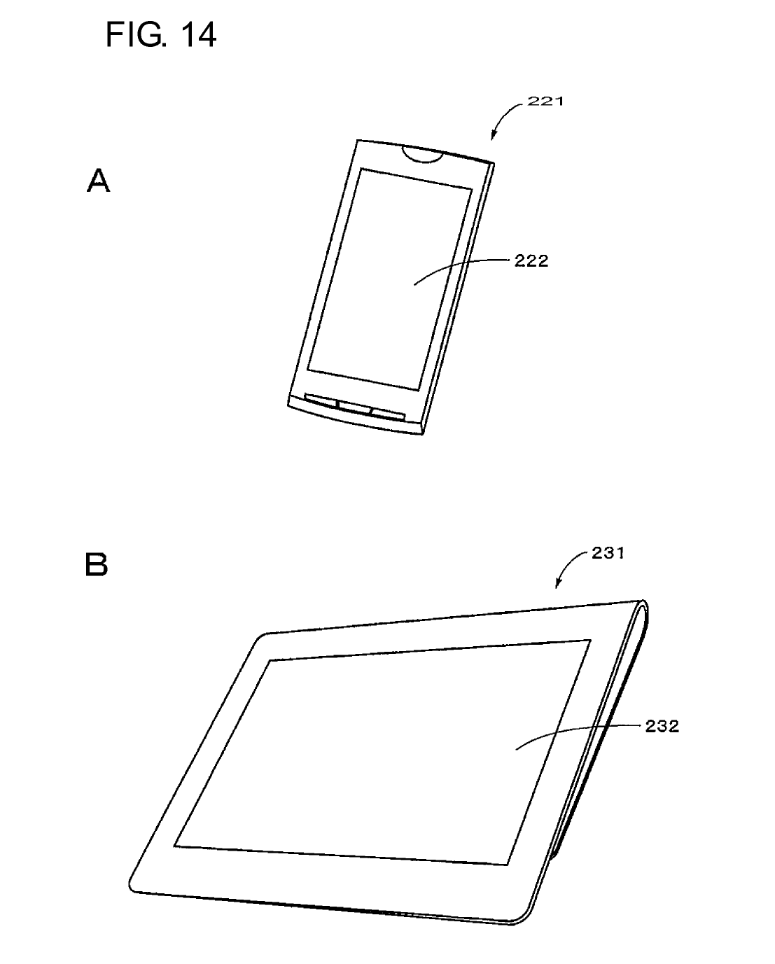

FIG. 14A is an outer appearance view of a mobile phone representing an example of the electronic apparatus. The mobile phone 221 is so-called a smart phone, and is provided with a display device 222 and any of the information input devices 102 in accordance with the fifth to the eighth embodiments either on the surface or inside of the display device 222.

FIG. 14B is an outer appearance view of a tablet type computer representing an example of the electronic apparatus. The tablet type computer 231 is provided with a display device 232 and any of the information input devices 102 in accordance with the fifth to the eighth embodiments either on the surface or inside of the display device 232.

### [Effects]

The electronic apparatuses in accordance with the ninth embodiment described above are provided with any of the information input devices 102 in accordance with the fifth to the eighth embodiments in the display device, thus, the visibility of the display device can be improved.

### EXAMPLES

The present technique will be described below in detail with reference to the following examples, however it should be construed that the present technique is in no way limited to these examples.

### Example 1

### Preparation Step of Coating Material for Forming Black Floating Prevention Layer

The coating material for forming the black floating prevention layer was prepared by mixing and dispersing the following materials. The blend ratio in preparing the coating material for forming the black floating prevention layer was adjusted, so that the black dye content in the black floating prevention layer was to be 0.250% by mass after drying and curing.

Black dye (manufactured by Nippon Kayaku Co., Ltd., trade name: Black YA)

Transparent resin material (manufactured by Wako Pure Chemical Industries, Ltd., Ethyl Cellulose (abt. 49% ethoxy))

Resin curing agent (manufactured by Asahi Kasei Co., Ltd., trade name: Duranate 17B-60P)

Curing-accelerating catalyst (manufactured by Nitto Kasei Co., Ltd., trade name: Neostann U-100)

### (Preparation Step of Coating Material for Forming Transparent Conductive Layer)

First, a silver nanowire was prepared as a metal nanowire. The silver nanowire having a diameter of 30 nm and a length of 10 to 30 μm was prepared using a known method through referring to the literature (ACS Nano, vol. 4, no. 5, pp. 2955-2963, 2010).

Next, the coating material for forming the transparent conductive layer was prepared by mixing and dispersing the following materials without breaking down the silver nanowires.

Silver Nanowire

Transparent resin material (manufactured by Wako Pure Chemical Industries, Ltd., Ethyl Cellulose (abt. 49% ethoxy))

Resin curing agent (manufactured by Asahi Kasei Co., Ltd., trade name: Duranate 17B-60P)

Curing-accelerating catalyst (manufactured by Nitto Kasei Co., Ltd., trade name: Neostann U-100)

Solvent (isopropyl alcohol (IPA) and methyl ethyl ketone (MEK))

### (Preparation Step of Protective Layer)

Next, the coating material for forming the protective layer was prepared by mixing and dispersing the following materials. The blend ratio of the materials was adjusted, so that the solid content in the coating material for forming the protective layer was to be 0.1% by mass.

Acrylic UV curing type resin (manufactured by Tesk Co., Ltd., trade name: A2398B)

Solvent (isopropyl alcohol (IPA))

### (Formation Step of Black Floating Prevention Layer)

Next, the coating material for forming the black floating prevention layer prepared as described above was coated on a surface of a transparent substrate by a coil bar No. 8 to form a coating film. As the transparent substrate, a sheet having a thickness of 100 μm (manufactured by Mitsubishi Plastics, Inc., trade name: Diafoil O300E) was used. Next, the coating film was subjected to a heat treatment in an oven at 120° C. for 5 min. to remove the solvent in the coating film by drying, and then subjected to the heat treatment at 150° C. for 30 min. to cure transparent resin materials in the coating film. Thus, the black floating prevention layer having the thickness of 10 nm was formed on the surface of the transparent substrate.

### (Formation Step of Transparent Conductive Layer)

Next, the coating material prepared as described above was coated on the surface of the black floating prevention layer by the coil bar No. 8 to form a coating film. By adjusting the basis weight of the silver nanowire to 0.02 g/m² or greater, sheet resistance was adjusted to about 100 Ω/(square). Next, the coating film was subjected to the heat treatment in the oven at 120° C. for 30 min. to remove the solvent in the coating film by drying, and then subjected to the heat treatment at 150° C. for 30 min to cure transparent resin materials in the coating film. Thus, the transparent conductive layer was formed on the surface of the black floating prevention layer.

### (Formation Step of Protective Layer)

Next, the coating material for forming the protective layer prepared as described above was coated on the surface of the black floating prevention layer by an applicator to form a coating film having a coating thickness (wet thickness) of 116 μm. Next, the coating film was dried in the oven at 80° C. for 2 min, then subjected to UV irradiation with a cumulative radiation of 300 mJ/cm². Thus, an acrylic resin layer having a thickness of about 100 nm was formed as the protective layer on the surface of the transparent conductive layer.

Consequently, a transparent conductive sheet as a target product was obtained.

### Example 2

A transparent conductive sheet was obtained in the same manner as in Example 1 except that the blend ratio of the coating material for forming the black floating prevention layer was adjusted, so that the black dye content in the black floating prevention layer was to be 0.400% by mass after drying and curing.

### Example 3

A transparent conductive sheet was obtained in the same manner as in Example 1 except that the blend ratio of the coating material for forming the black floating prevention layer was adjusted, so that the black dye content in the black floating prevention layer was to be 0.500% by mass after drying and curing.

### Example 4

A transparent conductive sheet was obtained in the same manner as in Example 1 except that carbon nanotubes were used in place of the black dyes as the raw materials of the coating material for forming the black floating prevention layer, and that the blend ratio of the coating material for forming the black floating prevention layer was adjusted, so that the carbon nanotube content in the black floating prevention layer was to be 0.063% by mass after drying and curing. Monolayer carbon nanotubes (SWCNT: Single Wall Carbon Nano Tube manufactured by KH Chemicals Co., Ltd.) were used as the carbon nanotubes.

### Example 5

A transparent conductive sheet was obtained in the same manner as in Example 4 except that the blend ratio of the coating material for forming the black floating prevention layer was adjusted, so that the carbon nanotube content in the black floating prevention layer was to be 0.143% by mass after drying and curing.

### Example 6

A transparent conductive sheet was obtained in the same manner as in Example 4 except that the blend ratio of the coating material for forming the black floating prevention layer was adjusted, so that the carbon nanotube content in the black floating prevention layer was to be 0.250% by mass after drying and curing.

### Example 7

A transparent conductive sheet was obtained in the same manner as in Example 1 except that the carbon nanotubes were further added as one of the raw materials of the coating material for forming the black floating prevention layer. The blend ratio of the coating material for forming the black floating prevention layer was adjusted so that the mixing ratio (mass ratio) of the black dye A to the carbon nanotube B, A:B, was to be 5:1, and the total content of the black dye A and the carbon nanotube B in the black floating prevention layer was to be 0.286% by mass after drying and curing. The monolayer carbon nanotubes (SWCNT: Single Wall Carbon Nano Tube manufactured by KH Chemicals Co., Ltd.) were used as the carbon nanotubes.

### Comparative Example 1

A transparent conductive sheet was obtained in the same manner as in Example 1 except that the transparent conductive layer was directly formed on the surface of the substrate by skipping the preparation step of the coating material for forming the black floating prevention layer and the formation step of the black floating prevention layer.

### [Characteristic Evaluation]

The transparent conductive sheets of Examples 1 to 7, and Comparative example 1 obtained as described above were evaluated in (A) total light transmittance [%], (B) haze [%], (C) sheet resistance [Ω/(square)], and (D) reflection L value, as following.

### (A) Evaluation of Total Light Transmittance

Total light transmittance was evaluated using a haze and transmittance meter (manufactured by Murakami color research laboratory, trade name: HM-150) in accordance with JIS K7361.

### (B) Evaluation of Haze

Haze was evaluated using the haze and transmittance meter (manufactured by Murakami color research laboratory, trade name: HM-150) in accordance with JIS K7136.

### (C) Evaluation of Sheet Resistance

Sheet resistance was evaluated using a manual type non-destructive resistance measurement instrument (manufactured by Napson Co., Ltd., trade name: EC-80P) by contacting a probe for measurement with the transparent conductive layer (wire layer) side of the surface.

### (D) Evaluation of Reflection L Value

Reflection L value, an index of the black floating was evaluated from the substrate side of the surface after putting a black tape to the transparent conductive layer side of the surface in accordance with JIS 28722 with a Color i5 manufactured by X-Rite, Incorporated.

Table 1 shows configurations of the transparent conductive sheets of Examples 1 to 7, and Comparative example 1.

TABLE 1

| | Coating Materials for Black Floating Prevention Layer/Conditions for Forming Film | | | | | | |
|---|---|---|---|---|---|---|---|
| | | | | | | Solid | |
| | | | | | | Concentration | |
| | | | | | | in Antiglare | Film |
| | Dyeing | | Carbon | | Mixing | Layer | Thickness |
| | Material | Manufacturer | Material | Manufacturer | Ratio | [% by mass] | [nm] |
| Example 1 | Black YA | Nippon | — | — | — | 0.250 | 10 |
| | | Kayaku Co., | | | | | |
| | | Ltd. | | | | | |
| Example 2 | Black YA | Nippon | — | — | — | 0.400 | 10 |
| | | Kayaku Co., | | | | | |
| | | Ltd. | | | | | |
| Example 3 | Black YA | Nippon | — | — | — | 0.500 | 10 |
| | | Kayaku Co., | | | | | |
| | | Ltd. | | | | | |
| Example 4 | — | — | Carbon | KH | — | 0.063 | 10 |
| | | | Nanotube | CHEMICAL | | | |
| Example 5 | — | — | Carbon | KH | — | 0.143 | 10 |
| | | | Nanotube | CHEMICAL | | | |
| Example 6 | — | — | Carbon | KH | — | 0.250 | 10 |
| | | | Nanotube | CHEMICAL | | | |
| Example 7 | Black YA | Nippon | Carbon | KH | 5:1 | 0.286 | 10 |
| | | Kayaku Co., | Nanotube | CHEMICAL | | | |
| | | Ltd. | | | | | |
| Comparative | — | — | — | — | — | — | — |
| Example 1 | | | | | | | |

Table 2 shows evaluation results of the transparent conductive sheets of Examples 1 to 7, and Comparative example 1.

TABLE 2

| | Total Light | | | |
|---|---|---|---|---|
| | Transmittance | HAZE | Sheet Resistance | Reflection L |
| | [%] | [%] | [Ω/(Square)] | [—] |
| Example 1 | 88.5 | 2.3 | 100 | 10.49 |
| Example 2 | 87.0 | 2.7 | 100 | 10.43 |
| Example 3 | 86.6 | 2.7 | 100 | 10.91 |
| Example 4 | 88.3 | 2.6 | 100 | 10.96 |
| Example 5 | 87.2 | 3.0 | 100 | 11.09 |
| Example 6 | 86.0 | 2.7 | 100 | 11.05 |
| Example 7 | 87.6 | 3.3 | 100 | 10.51 |
| Comparative | 89.1 | 3.2 | 100 | 11.30 |
| Example 1 | | | | |

### (Results)

It was made possible to improve reflection L values while completely suppressing any change in sheet resistance by introducing the black floating prevention layer, and thereby produce the transparent conductive layer (metal filler conductive layer) having higher contrast.

As the light-absorbing material, dyes or carbon materials (carbon nanotubes) may be used. When these materials are used in combination, high contrast can be still achieved similarly to when used separately.

### (Discussions)

When a light-absorbing material such as dyes or carbon materials is included in a transparent conductive layer, conductivity of a conductive sheet is impaired.

However, it is considered that the contrast of the conductive sheet is successfully improved without impairing conductivity of the conductive sheet by additionally providing a black floating prevention layer containing the light-absorbing material such as dyes or carbon materials.

It is considered that the contrast of the conductive sheet is improved without impairing conductivity of the conductive sheet since light irregularly reflected off a metal filler is absorbed by the provided black floating prevention layer.

The foregoing has described the embodiments of the present technique in detail, however, the present technique is not limited to the above-mentioned embodiments, and various kinds of variations based on technical ideas of the present technique are possible.

For example, configurations, methods, steps, forms, materials, numerical values, and the like described in the above embodiments are merely examples, and other different configurations, methods, steps, forms, materials, numerical values, and the like may be optionally used.

Further, configurations, methods, steps, forms, materials, numerical values, and the like described in the above embodiments may be used in any combination without departing from the scope of the present technique.

Furthermore, the following configurations may be adopted in the present technique.

(1)

A transparent conductor provided with:

a substrate;

a transparent conductive layer containing a metal filler; and

a light transmissive layer containing a light-absorbing material.

(2)

The transparent conductor as described in (1), wherein the light-absorbing material absorbs visible light.

(3)

The transparent conductor as described in (1), wherein the light-absorbing material is a colored compound that absorbs visible light.

(4)

The transparent conductor as described in (3), wherein the colored compound is a dye.

(5)

The transparent conductor as described in (3), wherein the colored compound has a chromophore.

(6)

The transparent conductor as described in (1), wherein the light-absorbing material is a carbon material.

(7)

The transparent conductor as described in any one of (1) to (6), wherein the transparent conductive layer has a light transmittance of 50% or higher with respect to visible light.

(8)

The transparent conductor as described in any one of (1) to (7), wherein the metal filler is a metal wire.

(9)

The transparent conductor as described in any one of (1) to (8), wherein the light transmissive layer is provided between the substrate and the transparent conductive layer.

(10)

The transparent conductor as described in any one of (1) to (9), wherein the transparent conductive layer is a transparent electrode.

(11)

The transparent conductor as described in any one of (1) to (10), wherein the transparent conductive layer further includes a binder.

(12)

An input device provided with:

a transparent conductive layer containing a metal filler; and

a light transmissive layer containing a light-absorbing material.

(13)

The input device as described in (12), wherein the light transmissive layer is provided at a position closer to an input surface than the transparent conductive layer.

(14)

An electric apparatus provided with:

a display device; and

an input device, wherein

the input device is provided with:

a transparent conductive layer containing a metal filler; and

a light transmissive layer containing a light-absorbing material.

(15)

The display device descried in (14), wherein the light transmissive layer is provided at a position closer to an input surface than the transparent conductive layer.

(16)

A transparent conductor provided with:

a substrate;

a transparent conductive layer containing a metal filler; and

a light transmissive layer containing a light-absorbing material, wherein

at least part of a surface of the metal filler is coated with a colored compound.

### REFERENCE SIGNS LIST

1 transparent conductor
11 substrate
12, 14 transparent conductive layer
13, 15 black floating prevention layer
101, 202, 212, 222, 232 display device
102 information input device
201 television device
211 notebook personal computer
221 mobile phone
231 tablet type computer

1. A transparent conductor comprising:
a substrate;
a transparent conductive layer containing a metal filler; and
a light transmissive layer containing a light-absorbing material.

2. The transparent conductor according to claim 1, wherein the light-absorbing material absorbs visible light.

3. The transparent conductor according to claim 1, wherein the light-absorbing material is a colored compound that absorbs visible light.

4. The transparent conductor according to claim 3, wherein the colored compound is a dye.

5. The transparent conductor according to claim 3, wherein the colored compound has a chromophore.

6. The transparent conductor according to claim 1, wherein the light-absorbing material is a carbon material.

7. The transparent conductor according to claim 1, wherein the light transmissive layer has a light transmittance of 50% or higher with respect to visible light.

8. The transparent conductor according to claim 1, wherein the metal filler is a metal wire.

9. The transparent conductor according to claim 1, wherein the light transmissive layer is provided between the substrate and the transparent conductive layer.

10. The transparent conductor according to claim 1, wherein the transparent conductive layer is a transparent electrode.

11. The transparent conductor according to claim 1, wherein the transparent conductive layer further includes a binder.

12. An input device comprising:
a transparent conductive layer containing a metal filler; and
a light transmissive layer containing a light-absorbing material.

13. The input device according to claim 12, wherein the light transmissive layer is provided at a position closer to an input surface than the transparent conductive layer.

14. An electronic apparatus comprising:
a display device; and
an input device, wherein
the input device is provided with:
a transparent conductive layer containing a metal filler; and
a light transmissive layer containing a light-absorbing material.

15. The display device according to claim 14, wherein the light transmissive layer is provided at a position closer to an input surface than the transparent conductive layer.

16. A transparent conductor comprising:
a substrate;
a transparent conductive layer containing a metal filler; and
a light transmissive layer containing a light-absorbing material, wherein
at least part of a surface of the metal filler is coated with a colored compound.
